(19) United States
(12) Patent Application Publication
(10) Pub. No.: US 2024/0148130 A1
(43) Pub. Date: May 9, 2024

(54) Marvelous Margin Holder

(71) Applicant: Mark Shigemi Oshiro, Wailuku, HI (US)

(72) Inventor: Mark Shigemi Oshiro, Wailuku, HI (US)

(21) Appl. No.: 18/317,615

(22) Filed: May 15, 2023

Related U.S. Application Data
(60) Provisional application No. 63/474,030, filed on Jul. 12, 2022.

(51) Int. Cl. A45F 5/02; F16M 13/04

(52) U.S. Cl. CPC A45F 5/021; F16M 13/04; A45F 2200/0575

(57) ABSTRACT

A margin holder for use in conjunction with margin trowels. These margin trowels for use in concrete, cleaning forms or other duties whereby the margin holder allows the user to carry the margin trowel hooked onto their belt when not in use.

### BRIEF DESCRIPTION OF THE DRAWING

FIG. 1 is a perspective view of present invention.

### DETAILED DESCRIPTION OF THE INVENTION

The Marvelous Margin Holder is made of a one piece round metal shaft with three rings welded to the shaft. It has a double U-shaped configuration set in opposing directions. The rings are welded between the main support, the three rings holds the margin trowel. The top U-shape is longer than the bottom U-shape, the top U-shape is where it hooks onto the belt or tool belt of the operator and the shorter bottom U-shape is the stopper for the margin trowel.

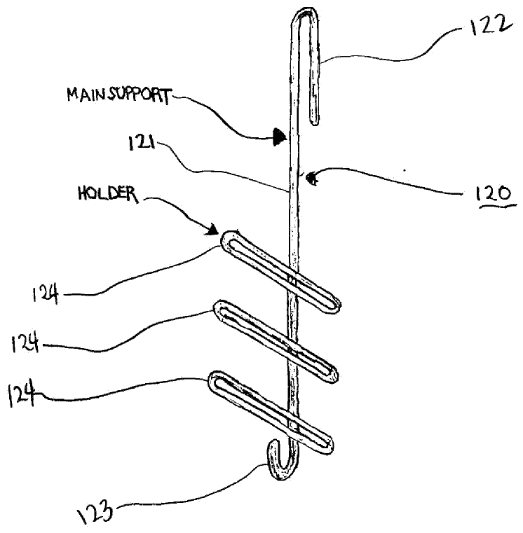

Referring to FIG. 1 where the Marvelous Margin Holder is shown as 120 and is in a perspective view, it can be seen that the Marvelous Margin Holder has a belt retaining portion 122 and an article supporting portion 121. The article shown in FIG. 1 the belt retaining portion 122 including a rear body wall 122, a frontal wall 121. The rear body wall 122 having a free end and a frontal wall 121 opposite from the rear wall 122.

Referring to FIG. 1 the article supporting portion 121 or main support, are three rings 124 that are spaced apart, and are welded to the frontal wall 121 or main support. The rings or holder 124 is where the margin trowel sits in.

Referring to FIG. 1 the article supporting portion 121 or main support and the bottom hook 123 is the stopper for the margin trowel.

1. A margin holder for supporting a margin trowel, said margin holder being supported by the belt of a worker, comprising:
a. A belt retaining portion.
b. An article supporting portion including three rings or holders welded to the article supporting portion.

2. The margin holder according to claim 1, wherein the article intended for supporting is a margin trowel.

3. The margin holder according to claim 1, wherein the margin holder is configured as a left handed margin trowel belt hook or a right handed margin trowel belt hook.
